(19) United States
(12) Patent Application Publication
(10) Pub. No.: US 2024/0068194 A1
(43) Pub. Date: Feb. 29, 2024

(54) FULL-SECTION ANTI-SLIDE WATER-CUT WALL FOR TREATING GIANT LANDSLIDE

(71) Applicant: Zaozhuang University, Zaozhuang (CN)

(72) Inventors: Hongkai CHEN, Zaozhuang (CN); Shengjuan WANG, Zaozhuang (CN); Zhibo CUI, Zaozhuang (CN); Liuxing WU, Zaozhuang (CN); Siqi CHEN, Zaozhuang (CN); Quancai WANG, Zaozhuang (CN); Baoliang WANG, Zaozhuang (CN)

(21) Appl. No.: 17/951,622

(22) Filed: Sep. 23, 2022

(30) Foreign Application Priority Data
Aug. 23, 2022 (CN) 2022110136835

(51) Int. Cl. E02D 17/20

(52) U.S. Cl. CPC E02D 17/207; E02D 2300/0029; E02D 2600/40

(57) ABSTRACT

Disclosed is a full-section anti-slide water-cut wall for treating giant landslides, which comprises at least one water-cut wall embedded in the landslide and arranged along the direction of blocking the movement of a sliding body; the water-cut wall comprises a plurality of anti-slide piles arranged at intervals, the bottom end of the anti-slide piles extend into the sliding bed, and a blocking wall is fixedly connected between adjacent anti-slide piles; the anti-slide pile and the blocking wall are provided with a plurality of drainage holes.

### CROSS-REFERENCE TO RELATED APPLICATIONS

This application claims priority to Chinese Patent Application No. 202211013683.5, filed on Aug. 24, 2022, the contents of which are hereby incorporated by reference.

### TECHNICAL FIELD

The application relates to the technical field of landslide treatment, and in particular to a full-section anti-slide water-cut wall for treating giant landslide.

### BACKGROUND

China is a country suffering many landslide disasters in the world, with a wide distribution, a large scale, frequent activities and considerable loss, which seriously threatens the infrastructure and operation safety of highways, railways, water transport, towns, mining areas, water conservancy and hydropower in mountainous areas of China, and threatens the lives and property safety of nearly 100 million residents. At present, China has achieved great success in treating small- and medium-sized landslides. Generally technical measures such as cantilever anti-slide piles, prestressed anchor cable anti-slide piles, cutting to reduce load, backfilling back pressure, intercepting and draining water, etc. are adopted. However, for giant landslides, because of its great impact, its engineering treatment is still a worldwide problem. According to the physical evolution theory of giant landslides, the formation and resurrection of most giant landslides are related to heavy rainfall or melting water of ice and snow, except for a few giant landslides caused by strong earthquakes. After heavy rainfall or melting water of ice and snow seeps into the landslide, the shear strength parameters of the sliding surface are deteriorated, and the weight of the landslide is increased, which significantly deteriorates the stability of the landslide, and fully demonstrates the significant role of groundwater in causing landslide disasters.

However, the existing landslide treatment facilities are not specially designed to solve the groundwater problem. Therefore, this application designs a full-section anti-slide water-cut wall for treating giant landslides to solve the above problems.

### SUMMARY

The objective of the present application is to provide a full-section anti-slide water-cut wall for treating giant landslide, so as to solve the problems existing in the prior art.

In order to achieve the above objective, the present application provides the following scheme: the present application provides a full-section anti-slide water-cut wall for treating giant landslides, which includes at least one water-cut wall embedded in a landslide; a bottom surface of the water-cut wall is inserted into a sliding bed of the landslide; a top end of the water-cut wall is flush with a sliding body of the landslide; and the water-cut wall is arranged along a direction of blocking a movement of the sliding body;
the water-cut wall includes a plurality of anti-slide piles arranged at intervals; a bottom end of the anti-slide pile extends into the slide bed; a blocking wall is fixedly connected between adjacent anti-slide piles; a bottom surface of the blocking wall is flush with the anti-slide pile; the anti-slide pile and the blocking wall are provided with a plurality of drainage holes through along a sliding direction of the sliding body;
the anti-slide pile includes a hollow outer pile; a bottom end of the outer pile extends into the sliding bed; the blocking wall is fixedly connected with the outer pile; an outer side wall of the outer pile is provided with a plurality of stabilizing mechanisms; the stabilizing mechanism is embedded and fixedly connected in the sliding bed and the sliding body respectively; the drainage holes respectively penetrate through two side walls of the outer pile in a moving direction of the sliding bed; the drainage hole is communicated with an inner cavity of the out pile; and the inner cavity of the outer pile is filled with supporting filler after installation.

Optionally, the stabilizing mechanism includes a reinforcing component and a combining component; the reinforcing component includes reinforcing holes penetrating the outer side wall of the outer pile; reinforcing piles is slidably connected in the reinforcing holes; one end of the reinforcing pile is located in the inner cavity of the outer pile; the other end of the reinforcing pile extends out of the reinforcing hole and is inserted into the sliding bed or the sliding body.

Optionally, the combining component includes a steel wire mesh embedded in the outer pile; the steel wire mesh is communicated with a plurality of jet pipes; one side of the jet pipe far away from the inner cavity of the outer pile extends out of the outer pile; the steel wire mesh is filled with microbial liquid under pressure, and the microbial liquid forms calcium carbonate.

Optionally, the microbial liquid includes urea hydrolysis bacteria, mixed solution of calcium chloride and urea.

Optionally, two side walls of the steel wire mesh are respectively fixedly connected with isolation plates; the jet pipe penetrates through the isolation plate and communicates with an inner cavity of the steel wire mesh.

Optionally, the inner cavity of the outer pile is detachably connected with an inner pile; a bottom surface of the inner pile is wedge-shaped; a side wall of the inner pile abuts against one end of the reinforcing pile located in the inner cavity of the outer pile; the inner pile is removed after the arrangement of the reinforcing pile is completed.

Optionally, the blocking wall includes two parallel wall plates; two ends of the wall plate are respectively fixedly connected with two sides of the bosses at two sides of the outer pile; bottom ends of the two wall plates are fixedly connected with a bottom plate; the wall plate is provided with a plurality of drainage holes; and the supporting filler is filled between the two wall plates.

Optionally, the steel wire mesh is embedded and fixedly connected to the wall plate; and one side of the steel wire mesh far away from the supporting filler is fixedly connected and communicated with the jet pipe.

Optionally, the drainage holes are obliquely arranged; the drainage holes on both sides are inclined to the inner cavity of the outer pile, and a dip angle is 10°-30°.

The application discloses the following technical effects.

The application discloses a full-section anti-slide water-cut wall for treating giant landslides. By arranging a through-drainage water-cut wall, the drainage of accumulated water and groundwater on the sliding surface is accelerated, the landslide effect caused by water flow is reduced, and the harm of giant landslides is reduced; at least one water-cut wall is arranged, and the bottom end of the water-cut is inserted into the sliding bed, so that the sliding of the sliding body is blocked, but the passage of underground water is not blocked, the discharge of underground water and accumulated water is accelerated, and the landslide caused by underground accumulated water is reduced; the water-cut wall includes several anti-slide piles, adjacent anti-slide piles are connected with blocking walls, and the anti-slide piles are used as supporting points and blocking walls are used as intercepting surfaces, so that the intercepting effect on sliding body is improved, and the drainage holes are used for accelerating the discharge of underground water; the stability mechanism of the outer pile is used to improve the stability of the anti-slide pile and the impact resistance of the anti-slide pile, thus improving the impact resistance of the water-cut wall; combined with the rapid drainage of underground water, the probability of giant landslide is greatly reduced and the loss of life and property caused by giant landslide is reduced. According to the application, the drainage of water in the sliding area is accelerated, the integrity of the sliding body and the sliding bed is increased, the occurrence probability of giant landslides is greatly reduced, and the safety of people's lives and property is effectively guaranteed.

### BRIEF DESCRIPTION OF THE DRAWINGS

In order to more clearly explain the embodiments of the present application or the technical solutions in the prior art, the following will briefly introduce the drawings that need to be used in the embodiments. Obviously, the drawings in the following description are only some embodiments of the present application. For those of ordinary skill in the art, other drawings can be obtained according to these drawings without any creative effort.

FIG. 1 is the structural schematic diagram of the full-section anti-slide water-cut wall for treating giant landslide according to the application

FIG. 2 is a schematic view of the top structure of the water-cut wall of the present application.

FIG. 3 is a schematic diagram of the anti-slide pile structure of the present application.

FIG. 4 is a partial enlarged view of A in FIG. 3.

FIG. 5 is a structural diagram of the blocking wall of the present application.

FIG. 6 is the installation schematic diagram of the reinforcing pile of the present application.

FIG. 7 is a structural schematic diagram of the reinforcing pile of the present application.

### DETAILED DESCRIPTION OF THE EMBODIMENTS

The technical solutions in the embodiments of the present application will be clearly and completely described below with reference to the drawings in the embodiments of the present application. Obviously, the described embodiments are only part of the embodiments of the present application, but not all of them. Based on the embodiment of the present application, all other embodiments obtained by ordinary technicians in the field without creative labor are within the scope of the present application.

In order to make the above objectives, features and advantages of the present application more obvious and understandable, the present application will be explained in further detail below with reference to the drawings and detailed description.

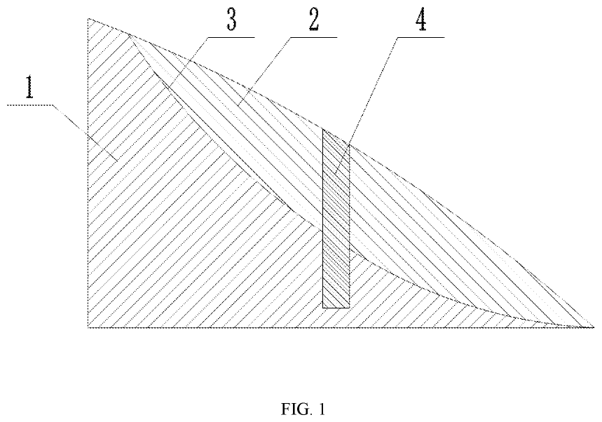

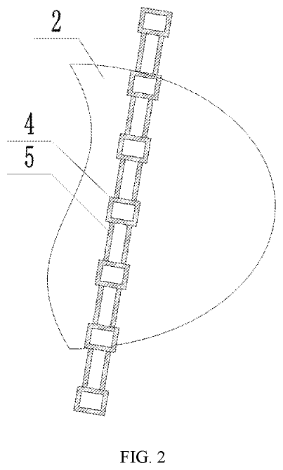

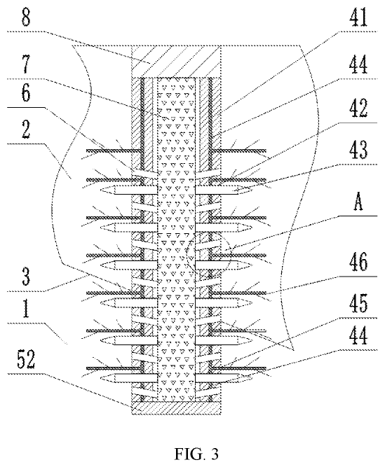

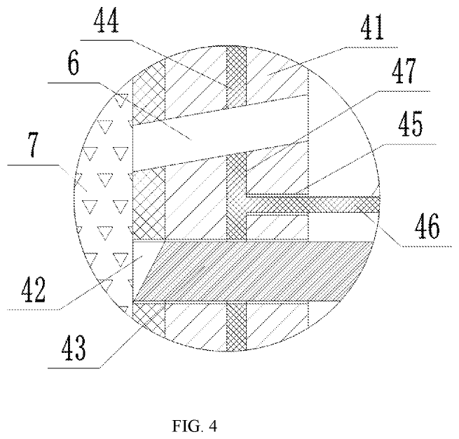

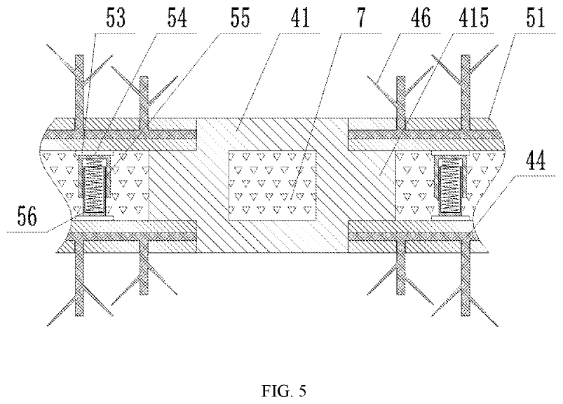

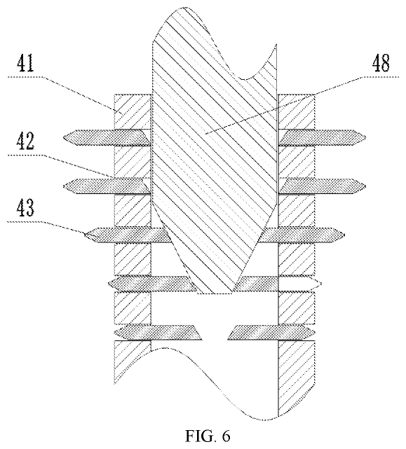

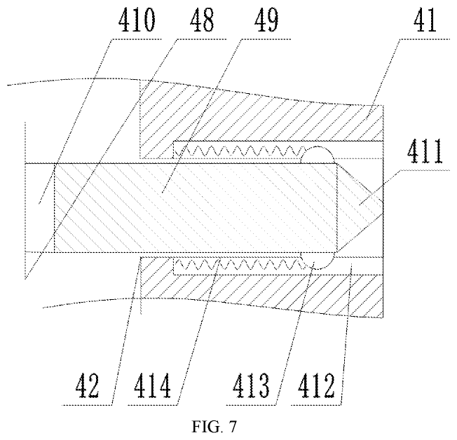

With reference to FIGS. 1-7, the present application provides a full-section anti-slide water-cut wall for treating giant landslides, including at least one water-cut wall embedded in a landslide; a bottom surface of the water-cut wall is inserted into a sliding bed 1 of the landslide; a top end of the water-cut wall is flush with a sliding body 2 of the landslide; and the water-cut wall is arranged along a direction of blocking a movement of the sliding body 2;
the water-cut wall includes a plurality of anti-slide piles 4 arranged at intervals; a bottom end of the anti-slide pile 4 extends into the slide bed 1; a blocking wall 5 is fixedly connected between adjacent anti-slide piles 4; a bottom surface of the blocking wall 5 is flush with the anti-slide pile 4; the anti-slide pile 4 and the blocking wall 5 are provided with a plurality of drainage holes 6 through along a sliding direction of the sliding body 2;
the anti-slide pile 4 includes a hollow outer pile 41; a bottom end of the outer pile 41 extends into the sliding bed 1; the blocking wall 5 is fixedly connected with the outer pile 41; an outer side wall of the outer pile 41 is provided with a plurality of stabilizing mechanisms; the stabilizing mechanism is embedded and fixedly connected in the sliding bed 1 and the sliding body 2 respectively; the drainage holes 6 respectively penetrate through two side walls of the outer pile 41 in a moving direction of the sliding bed 1; the drainage hole 6 is communicated with an inner cavity of the out pile 41; and the inner cavity of the outer pile 41 is filled with supporting filler 7 after installation.

The application discloses a full-section anti-slide water-cut wall for treating giant landslides, which is mainly used for treating giant landslides. By arranging a through-drainage water-cut wall, the drainage of accumulated water and groundwater on the sliding surface 3 is accelerated, the landslide effect caused by water flow is reduced, and the harm of giant landslides is reduced; at least one water-cut wall is arranged, and the bottom end of the water-cut is inserted into the sliding bed 1, so that the sliding of the sliding body 2 is blocked, but the passage of underground water is not blocked, the discharge of underground water and accumulated water is accelerated, and the landslide caused by underground accumulated water is reduced; the water-cut wall includes several anti-slide piles 4, adjacent anti-slide piles 4 are connected with blocking walls 5, and the anti-slide piles 4 are used as supporting points and blocking walls 5 are used as intercepting surfaces, so that the intercepting effect on sliding body 2 is improved, and the drainage holes 6 are used for accelerating the discharge of underground water; the stability mechanism of the outer pile 41 is used to improve the stability of the anti-slide pile 4 and the impact resistance of the anti-slide pile 4, thus improving the impact resistance of the water-cut wall; combined with the rapid drainage of underground water, the probability of giant landslide is greatly reduced and the loss of life and property caused by giant landslide is reduced.

Furthermore, crushed stone without powder is selected as the supporting filler 7, which has good water permeability as well as supporting property.

As a further optimization scheme, the stabilizing mechanism includes a reinforcing component and a combining component; the reinforcing component includes reinforcing holes 42 penetrating the outer side wall of the outer pile 41; reinforcing piles 43 is slidably connected in the reinforcing holes 42; one end of the reinforcing pile 43 is located in the inner cavity of the outer pile 41; the other end of the reinforcing pile 43 extends out of the reinforcing hole 42 and is inserted into the sliding bed 1 or the sliding body 2; the inner cavity of the outer pile 41 is detachably connected with an inner pile 48; a bottom surface of the inner pile 48 is wedge-shaped; a side wall of the inner pile 48 abuts against one end of the reinforcing pile 43 located in the inner cavity of the outer pile 41; the inner pile 48 is removed after the arrangement of the reinforcing pile 43 is completed. During installation, the inner pile 48 is inserted into the inner cavity of the outer pile 41, and the wedge-shaped inner pile 48 pushes the reinforcing pile 43 out of the outer pile 41 and inserts the reinforcing pile 43 into the sliding bed 1 and the sliding body 2, which improves the combination stability of the anti-slide pile 4 and the landslide structure, improves the blocking strength on the sliding body 2, and increases the sliding threshold of the sliding body 2. The inner pile 48 is removed after all the reinforcing pile 43 is pushed out, so as to prevent the addition of the supporting filler 7 from being blocked and the influence on the water permeability is prevented.

Further, the reinforcing pile 43 includes a pile body 49 slidably connected with the reinforcing hole 42, and one end of the pile body 49 facing the inner pile 48 is fixedly connected with a push block 410, and the push block 410 abuts against the outer wall of the inner pile 48. The end of the pile body 49 far from the push block 410 is fixedly connected with a tapered pile head 411, and the pile head 411 is made of hard material. When the inner pile 48 is inserted, the side wall of the inner pile 48 pushes the push block 410 to push out the pile body 49 of the reinforcing pile 43, so that the pile body 49 is inserted into the stratum, thus increasing the stability of the anti-slide pile 4; the tapered pile head 411 made of hard material is convenient to penetrate into the stratum.

Furthermore, the inner side wall of the reinforcing hole 42 is provided with a plurality of chutes 412, the outer wall of the pile body 49 of the reinforcing pile 43 is fixedly connected with a connecting block 413 which is matched with the chutes 412, and a spring 414 is fixedly connected between the connecting block 413 and the inner pile 48, so as to prevent the reinforcing pile 43 from sticking out when the outer pile 41 is installed; when the inner pile 48 pushes the reinforcing pile 43 out of the outer pile 41, the spring 414 extends.

As a further optimization scheme, the combining component includes a steel wire mesh 44 embedded in the outer pile 41, and the steel wire mesh is communicated with a plurality of jet pipes 45, and the side of the jet pipe 45 far away from the inner cavity of the outer pile 41 extends out of the outer pile 41; the steel wire 44 is pressurized and filled with microbial liquid, which forms calcium carbonate 46. The steel wire mesh 44 has permeability, and after being filled with microbial liquid under pressure, the microbial liquid is sprayed out from the jet pipe 45 to fill the gap between the outer pile 41 and the pile hole, and meanwhile, cracks are pressed out in the stratum and filling is carried out; after a period of time, the microbial liquid reaction produces calcium carbonate 46, which is the main component of the rock. Dendritic calcium carbonate 46 is produced in the crack, which increases the stability of the sliding body 2 itself and makes the outer pile 41 more closely combined with the stratum.

As a further optimization scheme, microbial liquid includes urea hydrolysis bacteria, mixed solution of calcium chloride and urea. Urea hydrolysis bacteria uses urea reaction to produce carbonate ions and react with the supplied calcium source, and finally, calcium carbonate cement structure is formed among soil particles, so as to reinforce the rock and soil mass. However, the key factor to the landslide is that a weak sliding surface with low shear strength is formed in the slope, and the shear force on the sliding surface is not enough to resist the thrust of the landslide, resulting in the landslide sliding along the sliding surface. However, through microbial grouting into the weak sliding zone to induce calcium carbonate precipitation, the shear strength of the weak sliding surface may be directly improved, which can effectively curb the occurrence of landslides. Moreover, the use of microbial injection to reinforce the slope may reduce the excavation of the slope and the damage to the environment.

As a further optimization scheme, two side walls of the steel wire mesh 44 are respectively fixedly connected with isolation plates 47; the jet pipe 45 penetrates through the isolation plate 47 and communicates with an inner cavity of the steel wire mesh 44. The isolation plate 47 prevents concrete from entering the steel wire mesh 44 when the outer pile 41 is poured; meanwhile, when the microbial liquid is added, the gap of the steel wire mesh 44 will be filled, and the strength of the outer pile 41 will be improved.

As a further optimization scheme, the blocking wall 5 includes two parallel wall plates 51, both ends of which are fixedly connected with the bosses 415 on both sides of the outer piles 41, and the bottom ends of the two wall plates 51 are fixedly connected with the bottom plates 52; a plurality of drainage holes 6 are formed through the wall plates 51, and supporting fillers 7 are filled between the two wall plates 51. The two wall plates 51 and the bottom plate 52 form a cavity, and the cavity is filled with supporting filler 7, which plays a supporting role and does not affect water permeability.

Furthermore, a number of buffering components are arranged between the two wall plates 51 to buffer the impact force generated by the sliding body 2; the buffering component includes cushion plates 53 fixedly connected to the end faces of two wall plates 51, one cushion plate 53 is fixedly connected with a fixed cylinder 54, the other cushion plate 53 is fixedly connected with a displacement cylinder 55, and the outer wall of the displacement cylinder 55 is slidably connected with the inner wall of the fixed cylinder 54; a spring damper 56 is fixedly connected between the inner cavity of the fixed cylinder 54 and the inner cavity of the displacement cylinder 55; when the wall plate 51 is impacted by the sliding body 2, the wall plate 51 may slightly displace, causing the displacement cylinder 55 and the fixed cylinder 54 to slide, compressing the spring damper 56, and the spring damper 56 absorbs the impact force of the wall, reduces the displacement of the wall, prevents the wall from being damaged by impact, and improves the impact resistance of the wall.

As a further optimization scheme, the steel wire mesh 44 is embedded and fixedly connected to the wall plate 51; and one side of the steel wire mesh 44 far away from the supporting filler 7 is fixedly connected and communicated with the jet pipe 45. The steel wire mesh 44 in the wall plate 51 has the same structure and use as the steel wire mesh 44 in the outer pile 41, so the description will not be repeated here.

In the further optimization scheme, the drainage holes 6 are obliquely arranged; the drainage holes 6 on both sides are inclined to the inner cavity of the outer pile 41, and a inclined angle is 10°-30°.

A method of application is as follows.

Firstly, prefabricating the outer pile 41 of the anti-slide pile 4; selecting the specific position of the anti-slide pile 4 at the appropriate position of the giant landslide; excavating and installing the pile hole of anti-slide pile 4 by pile jumping method, and installing the outer pile 41; inserting the inner pile 48 into the outer pile 41, pushing the reinforcing pile 43 out of the outer pile 41 and insert the reinforcing pile 43 into the side wall around the pile hole; injecting microbial bacteria liquid into the steel wire mesh 44 under pressure from the top, so that the microbial bacteria liquid is sprayed from the jet pipe 45 and flows into the gap between the outer pile 41 and the pile hole, and meanwhile, the periphery of the pile hole is fractured into dendritic cracks until the steel wire mesh 44 is fully filled; a drainage hole 6 is drilled in the anti-slide pile 4; filling the hollow part of the anti-slide pile 4 with supporting filler 7; the capping filler 8 is backfilled to the landslide surface after geotextile is laid on the top of the supporting filler 7, until all the anti-slide piles 4 are completed.

Secondly, the grooves among the anti-slide piles 4 for the construction of the blocking wall 5 are excavated in sections; the reinforce concrete bottom plate 52 and the wall plate 51 of the on-site inter-pile blocking wall 5 are poured and completely connected with the bottom of the anti-slide pile 4; then, the steel wire mesh 44 of the wall plate 51 is filled in the way of microbial liquid injection of the anti-slide pile 4; a drainage hole 6 is arranged in the inter-pile blocking wall 5 as required; arranging buffering components in the blocking wall 5 according to the designed spacing; backfilling supporting filler 7 in the inter-pile blocking wall 5; backfilling the capping filler 8 after laying geotextile on the top of the backfill supporting filler 7 until the backfill supporting filler 7 is flush with the surface of the landslide.

After the anti-slide pile 4 is installed in the middle and upper part of the giant landslide, the groundwater in the landslide body behind the pile may all enter the supporting filler 7 of the anti-slide retaining structure through the anti-slide pile 4 and the drainage hole 6 in the inter-pile blocking wall 5, and flow out of the landslide body through the anti-slide pile 4 and the drainage hole 6 of the blocking wall 5 at a fast speed, so as to ensure that the landslide body in front of the anti-slide pile 4 is not affected by groundwater.

In the description of the application, it is to be understood that the orientation or positional relations indicated by the terms “longitudinal”, “transverse”, “up”, “down”, “front”, “back”, “left”, “right”, “vertical”, “horizontal”, “top”, “bottom”, “inside”, “outside”, etc. are based on the orientation or positional relations shown in the accompanying drawings and are intended only to facilitate the description of the application and do not indicate or imply that the device or element referred to must have a particular orientation, be constructed and operated in a particular orientation, and are therefore not to be construed as limiting the application.

The above embodiments are only a description of the preferred way of the application and are not intended to limit the scope of the application. Without departing from the spirit of the design of the application, all kinds of variations and improvements made to the technical solutions of the application by persons of ordinary skill in the art shall fall within the scope of protection determined by the claims of the application.

What is claimed is:

1. A full-section anti-slide water-cut wall for treating giant landslides, comprising at least one water-cut wall embedded in a landslide; wherein a bottom surface of the water-cut wall is inserted into a sliding bed of the landslide; a top end of the water-cut wall is flush with a sliding body of the landslide; and the water-cut wall is arranged along a direction of blocking a movement of the sliding body; wherein
the water-cut wall comprises a plurality of anti-slide piles arranged at intervals; a bottom end of the anti-slide pile extends into the slide bed; a blocking wall is fixedly connected between adjacent anti-slide piles; a bottom surface of the blocking wall is flush with the anti-slide pile; the anti-slide pile and the blocking wall are provided with a plurality of drainage holes through along a sliding direction of the sliding body; and
the anti-slide pile comprises a hollow outer pile; a bottom end of the outer pile extends into the sliding bed; the blocking wall is fixedly connected with the outer pile; an outer side wall of the outer pile is provided with a plurality of stabilizing mechanisms; the stabilizing mechanism is embedded and fixedly connected in the sliding bed and the sliding body respectively; the drainage holes respectively penetrate through two side walls of the outer pile in a moving direction of the sliding bed; the drainage hole is communicated with an inner cavity of the out pile; and the inner cavity of the outer pile is filled with supporting filler after installation.

2. The full-section anti-slide water-cut wall for treating giant landslides according to claim 1, wherein the stabilizing mechanism comprises a reinforcing component and a combining component; the reinforcing component comprises reinforcing holes penetrating the outer side wall of the outer pile; a reinforcing pile is slidably connected in the reinforcing holes; one end of the reinforcing pile is located in the inner cavity of the outer pile; and the other end of the reinforcing pile extends out of the reinforcing holes and is inserted into the sliding bed or the sliding body.

3. The full-section anti-slide water-cut wall for treating giant landslide according to claim 2, wherein the combining component comprises a steel wire mesh embedded in the outer pile; the steel wire mesh is communicated with a plurality of jet pipes; one side of each jet pipe far away from the inner cavity of the outer pile extends out of the outer pile; and the steel wire mesh is filled with microbial liquid under pressure, and the microbial liquid forms calcium carbonate.

4. The full-section anti-slide water-cut wall for treating giant landslides according to claim 3, wherein the microbial liquid comprises urea hydrolysis bacteria, mixed solution of calcium chloride and urea.

5. The full-section anti-slide water-cut wall for treating giant landslides according to claim 3, wherein two side walls of the steel wire mesh are respectively fixedly connected with isolation plates; and the jet pipes penetrate through the isolation plate and communicates with an inner cavity of the steel wire mesh.

6. The full-section anti-slide water-cut wall for treating giant landslides according to claim 2, wherein the inner cavity of the outer pile is detachably connected with an inner pile; a bottom surface of the inner pile is wedge-shaped; a side wall of the inner pile abuts against one end of the reinforcing pile located in the inner cavity of the outer pile; and the inner pile is removed after the arrangement of the reinforcing pile is completed.

7. The full-section anti-slide water-cut wall for treating giant landslides according to claim 3, wherein the blocking wall comprises two parallel wall plates; two ends of each wall plate are respectively fixedly connected with two sides of the bosses at two sides of the outer pile; bottom ends of the two wall plates are fixedly connected with a bottom plate; each wall plate is provided with a plurality of drainage holes; and the supporting filler is filled between the two wall plates.

8. The full-section anti-slide water-cut wall for treating giant landslides according to claim 7, wherein the steel wire mesh is embedded and fixedly connected to the wall plates; and one side of the steel wire mesh far away from the supporting filler is fixedly connected and communicated with the jet pipes.

9. The full-section anti-slide water-cut wall for treating giant landslides according to claim 1, wherein the drainage holes are obliquely arranged; the drainage holes on both sides are inclined to the inner cavity of the outer pile, and an inclined angle is 10°-30°.
